(19) United States
(12) Patent Application Publication
(10) Pub. No.: US 2013/0194564 A1
(43) Pub. Date: Aug. 1, 2013

(54) METHOD AND APPARATUS FOR MEASURING PHOTOVOLTAIC CELLS

(71) Applicants: Chris Stapelmann, Portland, OR (US); Johannes Kirchner, Dresden (DE)

(72) Inventors: Chris Stapelmann, Portland, OR (US); Johannes Kirchner, Dresden (DE)

(73) Assignee: SOLARWORLD INDUSTRIES AMERICA, INC., Hillsboro, OR (US)

(21) Appl. No.: 13/358,706

(22) Filed: Jan. 26, 2012

(51) Int. Cl. G01J 3/28

(52) U.S. Cl. 356/72; 356/73

(57) ABSTRACT

A solar simulator is disclosed having a test chamber for receiving a photovoltaic device for testing, an illumination source for selectively illuminating the photovoltaic device to produce a test signal therefrom, a spectrophotometer for providing a measurement of the spectral distribution of the output of the illumination source, a database containing spectral response information of monitor cell, reference device and DUT, and a computation device for receiving said test signal and said measurement, wherein the computation device converts said test signal into a test value based on said measurement.

### FIELD OF THE INVENTION

Various embodiments relate generally to testing and measurement of photovoltaic (solar) cells and modules. More specifically, the present invention relates to a method and apparatus for compensating for spectral variation in solar cell testing and measurement.

### BACKGROUND

The grading of solar cell performance is accomplished in part by measurement under standard test conditions (STC). For example, exposure of a photovoltaic cell to conditions including standard irradiance of 1000 W/m², a solar spectrum of air mass 1.5 (AM1.5), and a module temperature of 25 deg. C. is considered STC for measurement of electrical characteristics including nominal power, (PMAX, measured in W), open circuit voltage (VOC), short circuit current (ISC, measured in amperes), maximum power voltage (VMPP), maximum power current (IMPP), peak power, Wp, and module efficiency, expressed as a percentage.

Performance testing can be accomplished by a device, such as a solar simulator, that exposes the photovoltaic device under test (DUT) to a spatially uniform illumination at STC. This can be accomplished by a flashlamp or constant light source. To the extent that a given illumination source may differ from the reference spectrum AM1.5, a spectral correction can be carried out to normalize the results obtained during the test. This process takes for granted, however, that the spectral characteristic of the light source remains constant from one test to the next (i.e. ignoring, for example, that over time the light source ages or the light source temperature changes e.g. due to self heating effects).

This is often not the case, particularly over long periods of illumination, or frequent flash illumination. FIG. 1 provides a plot of measured characteristics for a single device showing fluctuations in test results and a general downward trend in test values. PMAX is shown in plot 10 and ISC is shown in plot 20. This degradation can result from a change in the spectral character of the illumination source over time. The mismatch in spectrum between a new and an old bulb is shown in FIGS. 2a and 2b, respectively.

The result is that a properly calibrated test device can drift over time, invalidating the calibration and resulting in inaccurate measurement of DUTs.

### SUMMARY OF THE INVENTION

In accordance aspects of the present invention, a solar simulator, or cell flasher is disclosed that corrects measurement of photovoltaic solar cell performance automatically for the spectral mismatch between a monitor cell, DUT and the illumination source.

As to the illumination source, a spectrophotometer, or similar device such as a spectroradiometer is introduced into the illumination source or illumination path to provide spectrum-specific information about the illumination. This information can be provided at intervals or continuously, during calibration of the solar simulator, or in real time by simultaneously illuminating the spectrophotometer and the DUT during testing.

A computation device can integrate the output of the spectrophotometer with known spectral response information stored, for example, in a database. Compensation values can be calculated based on spectral mismatch between the illumination source and a reference spectrum, such as AM 1.5, and may include spectral information obtained or known to apply to the DUT or a monitor cell, such as information obtained empirically, or as provided by a laboratory or manufacturer.

Compensation can be applied to measurement results obtained from a DUT during illumination, either automatically, or selectively. When provided in real time, illumination spectrum information can be applied continuously to measurement results of the DUT, compensating for changes in illumination over multiple tests. Continuous, real-time acquisition of spectrum data can eliminate error introduced by changes in illumination sources over time, permitting longer effective illumination source (bulb) life, as well as consistently accurate test results. Elimination of variables related to illumination spectrum during testing also facilitates error analysis in the solar simulator.

A method for measuring the characteristics of a photovoltaic device is disclosed wherein a source of illumination is provided, a spectrophotometer and a DUT are exposed to the illumination to measure a characteristic of the DUT in response to the illumination compensated using spectral data received from the spectrophotometer.

The illumination of the spectrophotometer and the DUT may occur sequentially or simultaneously. The method can also be applied in a configuration including a monitor cell, which is illuminated either sequentially or in combination with the spectrophotometer and/or the DUT.

Illumination can be constant or of limited duration. In either case, the monitor cell may be used to provide intensity-related information used in the measurement of the DUT and/or compensation of raw measurements taken from the DUT.

A light source for a solar simulator is disclosed that illuminates a spectrophotometer which outputs spectrum-related information about the illumination for purposes of calculating a compensation value. The calculation of a compensation value may be accomplished by a computation device associated with the light source.

To the extent that the illumination is accompanied by information related to the spectral quality of the light, the light source may be said to be self-calibrating, as it provides illumination as well as data relevant to the spectrum and/or intensity of the light that can be used in correction/standardization of measured output from photovoltaic devices due to the illumination.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 is a plot illustrating sequential measurement of a DUT over time.

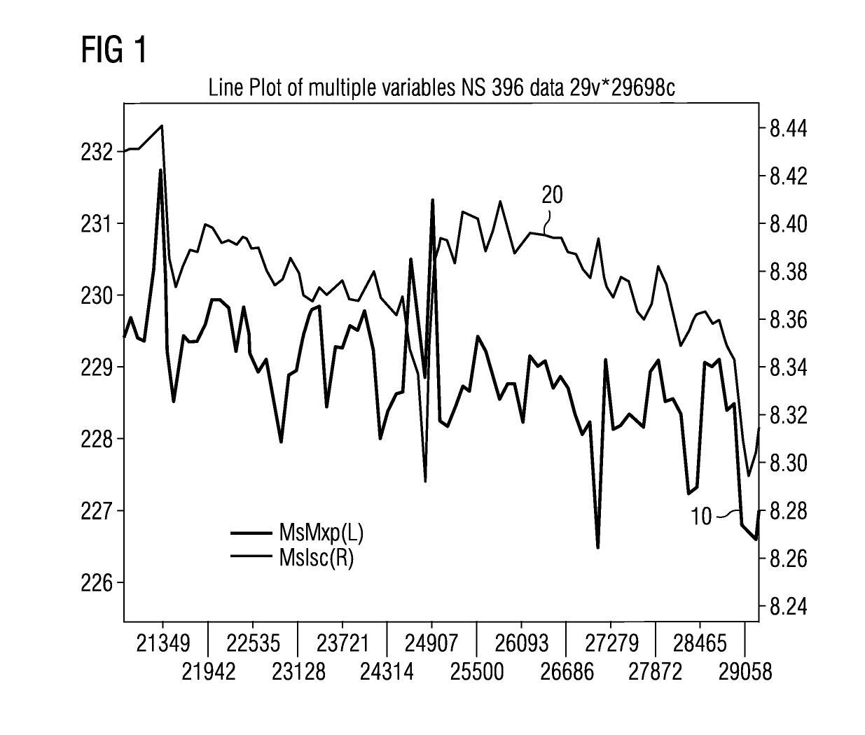

FIGS. 2A and 2B illustrate spectral intensity of a new and old illumination source, respectively.

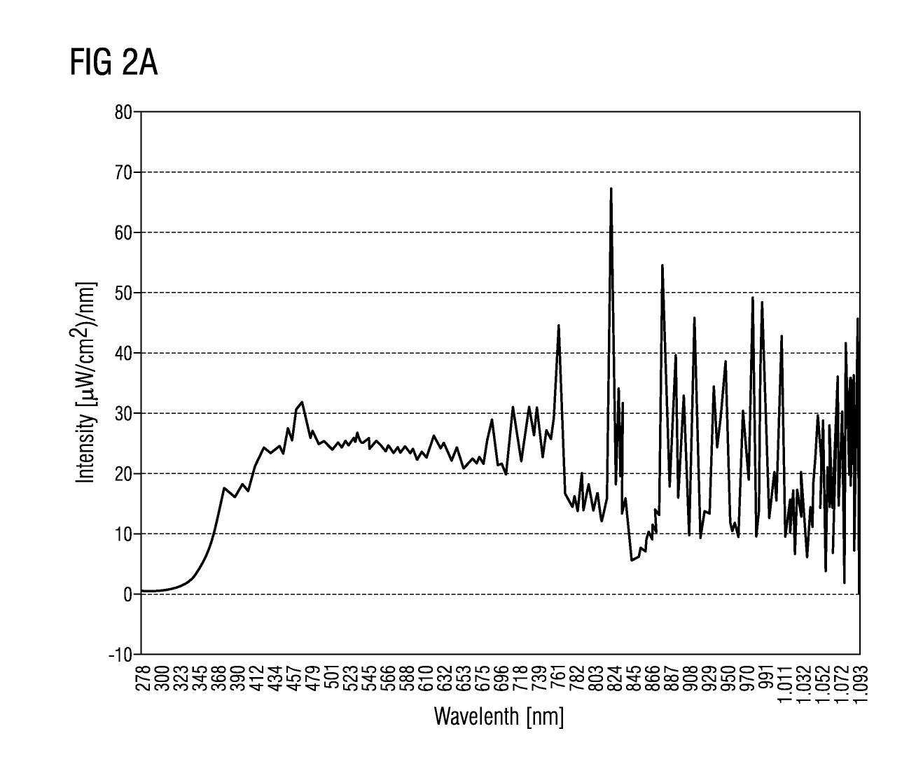

FIG. 3 is a spectral comparison of various illumination sources to the AM1.5 spectrum.

FIG. 4 is a block diagram of an embodiment of the test device of the present invention.

FIG. 5 is a flow chart of a method in accordance with an embodiment of the invention.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

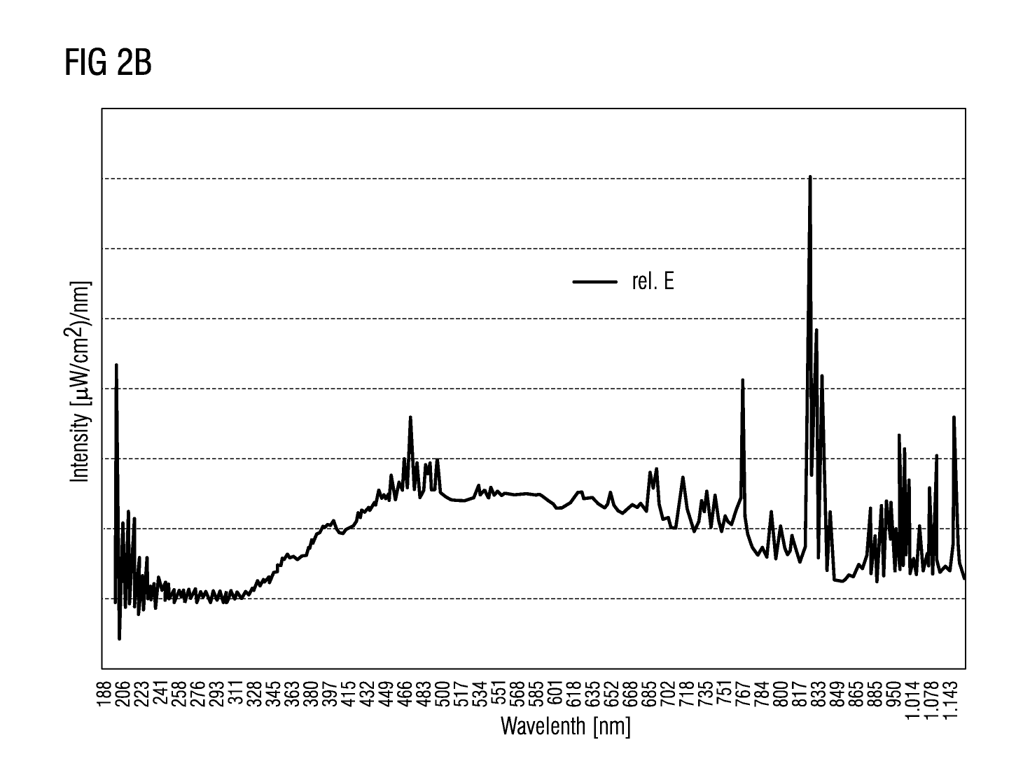

Although standards [IEC60904-3 ed.2] call for testing under standard test conditions (STC), it is not practical under most circumstances for photovoltaic devices under test (DUTs) to be tested under true STC conditions. The spectral irradiance of AM1.5 as a function of wavelength is shown in plot 30 of FIG. 3. A marked difference exists between the AM1.5 spectrum and the spectrum provided by artificial light sources such as mercury 40, xenon 50 and halogen 60, not only in intensity (plot 30 is read against the right axis, whereas plots 40, 50 and 60 are measured against the left), but also in terms of their spectral distribution.

The spectral distribution of illumination in a simulator system used for testing is critical because modern photovoltaic devices respond differently to different wavelengths of light. Because the artificial light in a simulator system does not readily follow the spectral irradiance specified under STC, measurements of a DUT taken with artificial light must compensate for the spectral mismatch (MM) between the reference spectrum and the illumination spectrum used in the test. To accomplish this, the spectrum of the flash bulb or illumination source must be known. This can be achieved by measuring the spectrum of the irradiance of the illumination source and providing a spectral correction factor (SCF) according to the equation:

$$S C F = \frac{\int {n}_{AM 1 , s} ( λ ) EQE ( λ ) d λ}{\int {n}_{spec} ( λ ) EQE ( λ ) d λ}$$

where:

n_{AM} is the reference spectrum, and

n_{spec} is the measured spectrum of the illumination source.

The intensity of the light source in a simulator system is set with the aid of a reference cell. The reference cell which thus calibrates the simulator system is typically a photovoltaic cell which has been carefully characterized by precise measurements of its parameters including spectral responsivity (SR). Because the measured intensity of a light source depends on the SR of the reference cell, the spectral mismatch between the reference cell and the DUT must also be known. Per IEC60904-7, the following equation is used:

$$MM = \frac{\int {E}_{ref} ( λ ) {S}_{ref} ( λ ) d λ \int {E}_{meas} ( λ ) {S}_{sample} ( λ ) d λ}{\int {E}_{meas} ( λ ) {S}_{ref} ( λ ) d λ \int {E}_{ref} ( λ ) {S}_{sample} ( λ ) d λ}$$

where:

E_{ref}(λ) is the irradiance per unit bandwidth at a particular wavelength λ of the reference spectral irradiance distribution, for example as given in IEC 60904-3;

Eₘₑₐₛ(λ) is the irradiance per unit bandwidth at a particular wavelength λ, of the spectral irradiance distribution of the incoming light at the time of measurement;

S_{ref}(λ) is the spectral response of the reference photovoltaic device; and

Sₛₐₘₚₗₑ(λ) is the spectral response of the test photovoltaic device.

Using this mismatch factor MM, the short circuit current (ISC) of the DUT can be corrected and the I-V curve can be shifted accordingly to yield a spectrally corrected power measurement of the DUT:

$${I}_{SC , sample , {E}_{mean}} = MM * {I}_{SC , sample , {E}_{ref}} * \frac{{I}_{SCref , {E}_{mean}}}{{I}_{SCref , {E}_{ref}}}$$

Typically, the device used for calibrating the apparatus is spectrally matched to the DUT, i.e. it is produced from the population of DUTs. A small spectral mismatch may still exist between such DUT and the reference device, however, by using average SR curves from multiple similar reference devices reduces this spectral mismatch further.

In this way, provided the spectral characteristics of the illumination source and the reference cell remain constant, or at least known, stable and accurate measurement of the performance of the DUT under simulated STC conditions can be made. However, should the spectral output of the illumination source drift over time, the test results would no longer be appropriately corrected by the calculated SCF, resulting in inaccurate measurement of DUTs. Accordingly, a real-time assessment of the spectrum of light provided by the illumination source allows for similarly real-time calculation of SCF, maintaining stable, accurate test results.

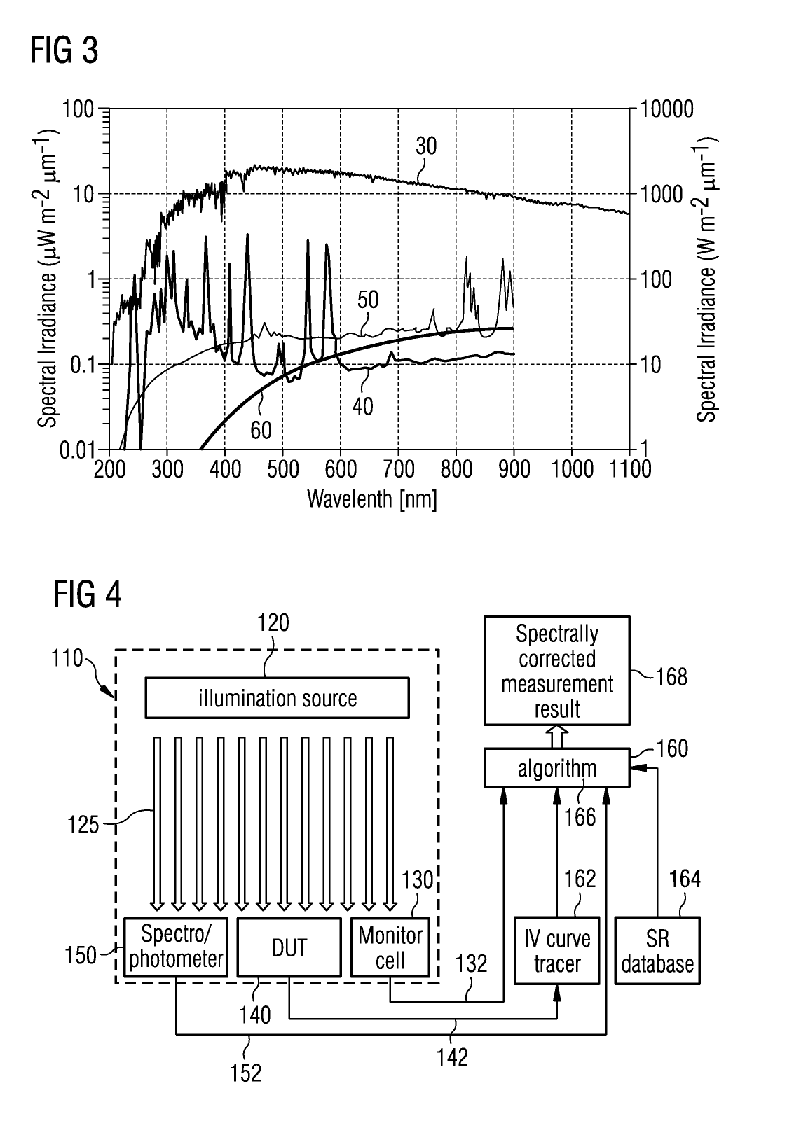

FIG. 4 illustrates an embodiment of a test device such as a solar simulator system for testing and characterizing photovoltaic devices. Simulator chamber 110, which is ideally light-tight, is shown housing illumination source 120, which may be one or more xenon flash tubes, or any other illumination source having a suitable spectral range. The apparatus described herein will further allow the usage of less expensive light sources that have a greater mismatch with the AM1.5 spectrum, thus reducing equipment and maintenance cost over the life of the apparatus. The illumination source is shown oriented within chamber 110 such that emitted light energy 125 will illuminate monitor cell 130, DUT 140 and spectrophotometer 150.

Spectrophotometer 150 is a device such which is able to determine the relative contribution of light over an appropriate range of wavelengths relevant to the photovoltaic device being tested. The term “spectrophotometer” as used herein is considered generic to any device having similar functionality, including a spectroradiometer.

Each of monitor cell 130, DUT 140 and spectrophotometer 150 have output terminals 132, 142 and 152 respectively which are connected to computation device 160 programmed with algorithm 166. The computation device may be any computer-based data acquisition system capable of interpreting the inputs from monitor cell 130, DUT 140 and spectrophotometer 150, respectively. As shown, the DUT may be connected to computation device 160 through power (IV) curve tracer 162. The capability of curve tracer 162, if needed, may also be integrated into computation device 160. Spectral response (SR) database 164 is independently connected to computation device 160.

SR database 164 contains the data for the reference solar spectrum, the SR of the monitor cell and/or reference devices used to calibrate the apparatus. The spectral response curve of DUT 140 may also be stored in SR database 164. Algorithm 166 enables calculation of spectral mismatch and compensation of measurement results 168 accordingly.

During operation, illumination source 120 is triggered, illuminating monitor cell 130, DUT 140 and spectrophotometer 150. Ideally, the illumination of each of monitor cell 130, DUT 140 and spectrophotometer 150 takes place simultaneously. In such a case, variations in illumination that may occur between sequential illuminations would not affect the test results. However, non-simultaneous illumination can also be implemented, particularly where spectral drift in the illumination source can be assumed to take place over longer periods of time.

The intensity of the beam should be uniform across each illuminated component, and may be controlled according to output from monitor cell 130. The output of monitor cell 130 is provided to computation device 160, which processes the signal based on known characteristics of the monitor cell, and illumination source 120, stored for example in SR database 164. The signal thereby provides a reliable measure of illumination intensity within simulator chamber 110.

Likewise illumination of DUT 140 generates a signal which is provided to computation device 160. IV curve tracer records the performance of DUT 140 during illumination, which results are corrected according to the known spectral mismatch between illumination source 120 and the AM1.5 spectrum, as well as the mismatch between the DUT and the monitor cell, providing spectrally corrected measurement result 168.

Spectrophotometer 150 provides information related to the spectral output of illumination source 120 during illumination for test. To the extent that this information confirms the known spectral characteristics of illumination source 120 as it may be stored in SR database 164, the data from spectrophotometer 150 merely confirms that measurement result 168 is unlikely to be affected by errors due to drift in the illumination spectrum. The spectrophotometer 150 can also provide a measurement of the absolute illumination/irradiation for regulating the illumination source and light intensity correction calculations.

Should the spectrum of illumination source 120 change over time, however, output from spectrophotometer 150 can be used by algorithm 166 of computation device 160 to correct for such changes, thereby maintaining the accuracy of measurement result 168. By integrating data from spectrophotometer 150 into each test, variables introduced into the measurement of DUT 140 by changes in illumination characteristics can be eliminated in real-time, eliminating the need for periodic recalibration of the simulator system. Additionally, measurement error caused by other effects such as temperature can also be compensated for. For example, SR curves for monitor cell 130, reference device and DUT 140 for different temperature can also be stored in the database 164.

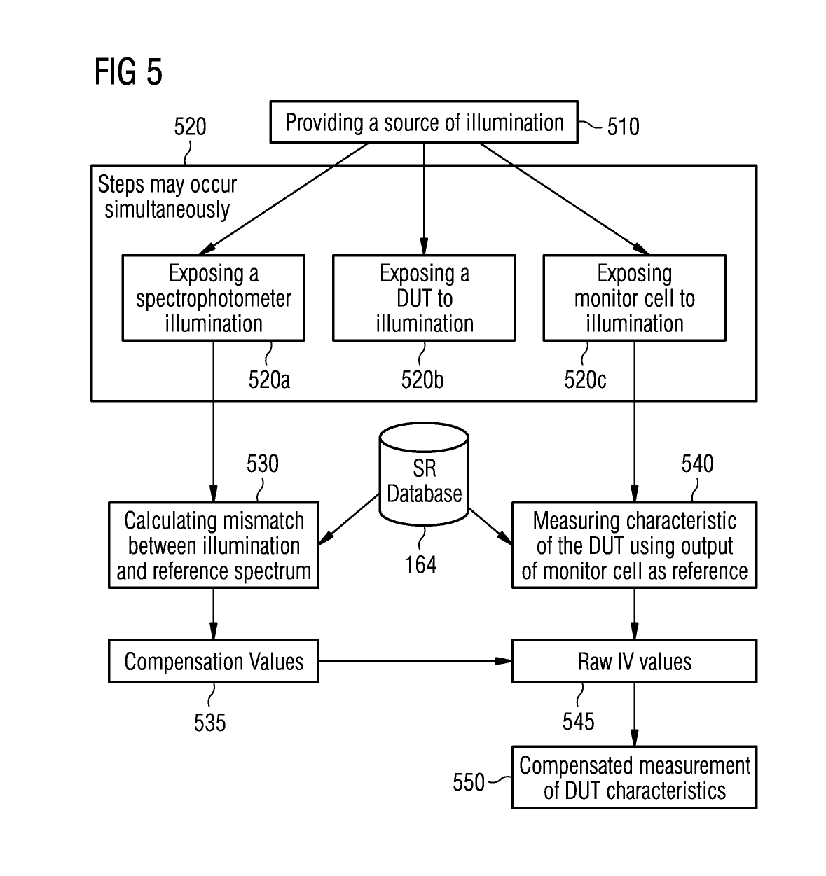

FIG. 5 is a flowchart illustrating a method in accordance with an embodiment of the invention. As shown, a source of illumination is provided in step 510. In step 520, each of the spectrophotometer, DUT and monitor cell is exposed to the illumination in steps 520a, 520b and 520c, respectively. Ideally, the illumination of the components in step 520 takes place simultaneously, although they may also be performed sequentially.

SR database 164 is shown providing stored spectrum information for purposes of completing the calculation of mismatch between illumination and reference spectrum in step 530, and for measuring the characteristics of the DUT in step 540. Steps 530 and 540 may be performed independently, and may ideally be calculated according to the disclosed equations, or by any calculation approach known in the art. As noted herein, these steps may be performed by a computation device, employing known or specialized algorithms.

The result of each of steps 530 and 540 is a compensation value 535 and a raw (uncorrected/uncompensated) IV value 545. Application of the compensation value to the IV value results in a compensated measurement of DUT characteristics as shown in step 550.

The apparatus and method disclosed herein results in a more accurate and stable power measurement of DUT 140. Spectral response curves of the monitor cell are typically provided by the flasher manufacturer, whereas spectral response curves of the DUT can be provided from representative samples (e.g. reference modules). Spectral response curves of calibration devices (calibration panels) are measured and provided by calibration laboratories. These curves, when stored in SR database 164 enable algorithm 166 to integrate the spectral distribution of the illumination source into the calculation of power measurements from DUT 140, providing reliable results for the DUT related to ISC, VOC, FF, Rser and Rshunt measurements as provided in IEC 60904-7.

The addition of a spectrophotometer within the illuminated portion of simulation chamber enables accurate DUT measurement, even following substantial spectral drift in the lamps used as an illumination source. Accordingly, lamps can be used long after they would be considered unstable, thereby extending the working life of the illumination source. By themselves, however, accurate DUT measurements ensure that photovoltaic devices are properly characterized.

In addition, embodiments of the present invention may relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

What is claimed is:

1. A solar simulator comprising:
a test chamber for receiving a photovoltaic device for testing;
an illumination source for selectively illuminating the photovoltaic device to produce a test signal therefrom;
a spectrophotometer for providing a measurement of the spectral distribution of the output of the illumination source;
a computation device for receiving said test signal and said measurement;
wherein the computation device converts said test signal into a test value based on said measurement.

2. A solar simulator comprising:
a test chamber for receiving a photovoltaic device for testing;
an illumination source for selectively illuminating the photovoltaic device to produce a test signal therefrom;
a spectrophotometer for providing a measurement of the absolute illumination/irradiation for regulating the illumination source and light intensity correction calculations;
a computation device for receiving said test signal and said measurement;
wherein the computation device converts said test signal into a test value based on said measurement.

3. The solar simulator of claim 1 wherein the photovoltaic device and the spectrophotometer are illuminated simultaneously by the illumination source.

4. The solar simulator of claim 2 further comprising a monitor cell housed within said test chamber for illumination with the photovoltaic device.

5. The solar simulator of claim 3 wherein the spectral response characteristics of the photovoltaic device and the monitor cell are known.

6. The solar simulator of claim 4 wherein the computation device further comprises a spectral response database for storing the spectral response characteristics of at least one of the photovoltaic device and the monitor cell.

7. The solar simulator of claim 4 wherein the test value is based on an output from said monitor cell.

8. The solar simulator of claim 5 further comprising a power curve tracer for processing the test signal of said photovoltaic device.

9. The solar simulator of claim 7 wherein the computation device comprises an algorithm that performs at least one of the following calculations:
a. spectral mismatch between the photovoltaic device and the monitor cell, and
b. spectral mismatch between the spectral distribution of the output of the illumination source and a reference spectrum.

10. The solar simulator of claim 8 wherein said test value is corrected by said at least one spectral mismatch calculation.

11. A method for measuring the characteristics of a photovoltaic device comprising:
providing a source of illumination;
exposing a spectrophotometer to said illumination to obtain spectral data related to said illumination;
exposing the photovoltaic device to said illumination;
measuring a characteristic of the photovoltaic device in response to said illumination; and
compensating said measurement in accordance with said spectral data.

12. The method of claim 10 wherein said spectrophotometer and said photovoltaic device are illuminated simultaneously.

13. The method of claim 11 wherein said source of illumination is a flashlamp, and said illumination is pulsed for a period of time.

14. The method of claim 12 further comprising:
exposing a monitor cell or a spectrophotometer to said illumination to obtain intensity data related to said illumination; and at least one of
a. compensating said measurement in accordance with said intensity data, or
b. adjusting the intensity of said illumination in accordance with said intensity data.

15. The method of claim 13 further comprising calculating the spectral mismatch between said illumination and a reference spectrum.

16. The method of claim 14 further comprising calculating the mismatch in spectral performance between said photovoltaic device and the monitor cell.

17. A self-calibrating light source for a solar simulator comprising:
an illumination source for selectively providing illumination of a test area;
a spectrophotometer located in said test area for providing first output related to said illumination;
a computation device for calculating a compensation value from said first output.

18. The self-calibrating light source of claim 16 further comprising a monitor cell in said test area for providing a second output related to said illumination;

19. The self-calibrating light source of claim 16 wherein said first output includes spectral data related to said illumination.

20. The self-calibrating light source of claim 18 wherein said compensation value is provided relative to a standard spectrum.

21. The self-calibrating light source of claim 17 wherein said second output includes data related to the intensity of said illumination.
